(19) United States
(12) Patent Application Publication
(10) Pub. No.: US 2009/0099390 A1
(43) Pub. Date: Apr. 16, 2009

(54) Crystalline forms of ibandronic acid and processes for the preparation thereof

(75) Inventors: Claude Singer, Kfar Saba (IL); Sharon W. Avhar-Maydan, Givataym (IL); Tamas Koltai, Netanya (IL); Amir Gold, Herzelia (IL)

Correspondence Address: KENYON & KENYON LLP, ONE BROADWAY, NEW YORK, NY, 10004, US

(73) Assignee: Teva Pharmaceutical Industries Ltd.

(21) Appl. No.: 12/284,811

(22) Filed: Sep. 24, 2008

Related U.S. Application Data
(60) Provisional application No. 60/974,574, filed on Sep. 24, 2007.
(60) Provisional application No. 60/983,485, filed on Oct. 29, 2007.
(60) Provisional application No. 61/075,220, filed on Jun. 24, 2008.
(60) Provisional application No. 61/077,361, filed on Jul. 1, 2008.

(51) Int. Cl. C07F 9/38

(52) U.S. Cl. 564/15

(57) ABSTRACT

A crystalline ibandronic acid characterized by data selected from the group consisting of at least one of a powder x-ray diffraction pattern having peaks at about 4.1, 12.3 and 13.4±0.2 degrees two-theta and at least two more peaks selected from the group consisting of: 8.2, 11.3, 16.2 and 16.9 and 20.8±0.2 degrees two-theta, and by a powder X-ray diffraction pattern depicted in FIG. 1 is provided. Also provided is a crystalline ibandronic acid characterized by data selected from the group consisting of at least one of a powder x-ray diffraction pattern having peaks at about peaks at about 5.2, 11.7, and 18.7±0.2 degrees two-theta and at least two more peaks selected from the group consisting of: 5.8, 10.1, 12.0, 17.1, and 20.0±0.2 degrees two-theta and a powder X-ray diffraction pattern as depicted in FIG. 2. Methods of preparing the crystalline forms are also provided.

### CROSS REFERENCE TO RELATED APPLICATIONS

This application claims priority to U.S. Provisional Application 60/974,574, filed Sep. 24, 2007; U.S. Provisional Application 60/983,485, filed Oct. 29, 2007; U.S. Provisional Application 61/075,220, filed Jun. 24, 2008; and U.S. Provisional Application 61/077,361, filed Jul. 1, 2008.

### FIELD OF THE INVENTION

The invention encompasses crystalline forms of ibandronic acid and processes for their preparation.

### BACKGROUND OF THE INVENTION

Ibandronate sodium, (1-hydroxy-3-(N-methyl-N-pentylamino)propylidene) bisphosphonic acid monosodium salt, is a third-generation nitrogen-containing bisphosphonate characterized by an aliphatic tertiary amine side chain. Ibandronate sodium is a white crystalline powder and has the following chemical structure:

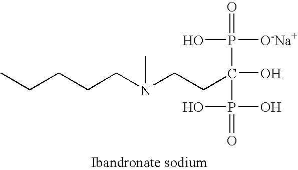

Ibandronate sodium is currently marketed in the United States by Hoffmann-La Roche under the tradename BONIVA®. BONIVA® is indicated for the treatment and prevention of osteoporosis in post-menopausal women. BONIVA® is available as an intravenous injection administered every 2-3 months or as an oral formulation. BONIVA® is also marketed in Europe under the tradename BONDRONAT® for the treatment of skeletal-related events in patients with breast cancer and bone metastases.

Ibandronate salts, such as ibandronate sodium, are generally prepared from ibandronic acid, which has the following chemical structure:

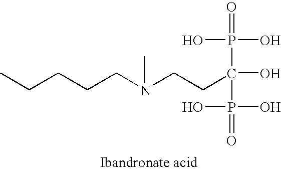

U.S. Pat. No. 4,927,814 discloses diphosphonic acid derivatives, processes for the preparation thereof, and pharmaceutical compositions containing them.

Further, International Publication No. WO 2006/002348 (“WO'348”) discloses amorphous and crystalline forms of ibandronic acid. Among others, WO'348 discloses a crystalline form of ibandronic acid denominated Form S1, characterized by a powder X-ray diffraction pattern having peaks at about 8.2, 11.5, 11.9, 13.9, 18.6 and 22.2±0.2 degrees two-theta, as well as the preparation thereof.

International Publication No. WO 2007/127249 (parallel to US Publication No. 2008/0009466) discloses crystalline forms of ibandronic acid, denominated Form S15, characterized by a powder X-ray diffraction pattern having peaks at about 8.2, 11.4, 11.8, 22.0 and 24.5±0.2 degrees two-theta, and Form S16, characterized by a powder X-ray diffraction pattern having peaks at about 4.7, 12.4, 16.4, 20.8 and 22.7±0.2 degrees two-theta.

International Publication No. WO 2008/014510 discloses a crystalline Form A of ibandronic acid.

Polymorphism, the occurrence of different crystal forms, is a property of some molecules and molecular complexes. A single molecule may give rise to a variety of crystalline forms having distinct crystal structures and physical properties like melting point, X-ray diffraction pattern, infrared absorption fingerprint, and solid state nuclear magnetic resonance spectrum. One crystalline form may give rise to thermal behavior different from that of another crystalline form. Thermal behavior can be measured in the laboratory by such techniques as capillary melting point, thermogravimetric analysis (“TGA”), and differential scanning calorimetry (“DSC”), which have been used to distinguish polymorphic forms.

The difference in the physical properties of different crystalline forms results from the orientation and intermolecular interactions of adjacent molecules or complexes in the bulk solid. Accordingly, polymorphs are distinct solids sharing the same molecular formula yet having distinct advantageous physical properties compared to other crystalline forms of the same compound or complex.

One of the most important physical properties of pharmaceutical compounds is their solubility in aqueous solution, particularly their solubility in the gastric juices of a patient. For example, where absorption through the gastrointestinal tract is slow, it is often desirable for a drug that is unstable to conditions in the patient's stomach or intestine to dissolve slowly so that it does not accumulate in a deleterious environment. Different crystalline forms or polymorphs of the same pharmaceutical compounds can and reportedly do have different aqueous solubilities.

The discovery of new polymorphic forms of active pharmaceutical ingredients (“APIs”) provides a new opportunity to improve the performance characteristics of the API, such as flowability and solubility. These characteristics can aid in the synthesis and/or administration of the API.

### SUMMARY OF THE INVENTION

In one embodiment, the invention encompasses a crystalline ibandronic acid characterized by data selected from the group consisting of at least one of a powder X-ray diffraction pattern having peaks at about 4.1, 12.3, and 13.4±0.2 degrees two-theta and at least two more peaks selected from the group consisting of: 8.2, 11.3, 16.2, 16.9, and 20.8±0.2 degrees two-theta, and a powder X-ray diffraction pattern as depicted in FIG. 1.

In another embodiment, the invention encompasses a crystalline ibandronic acid characterized by data selected from the group consisting of at least one of a powder X-ray diffraction pattern having peaks at about 4.1, 8.2, 12.3, and 13.4 degrees two-theta±0.2 degrees two-theta, and a powder X-ray diffraction pattern as depicted in FIG. 1.

In yet another embodiment, the invention encompasses a process for preparing the above-described crystalline ibandronic acid comprising slurrying crystalline ibandronic acid Form S1 in 1-butanol.

In one embodiment, the invention encompasses a process for preparing ibandronate sodium comprising preparing crystalline ibandronic acid characterized by data selected from the group consisting of at least one of a powder X-ray diffraction pattern having peaks at about 4.1, 8.2, 12.3, and 13.4 degrees two-theta±0.2 degrees two-theta and a powder X-ray diffraction pattern as depicted in FIG. 1 by the above-described process, and converting the crystalline ibandronic acid into ibandronate sodium.

In another embodiment, the invention encompasses the use of the crystalline ibandronic acid characterized by data selected from the group consisting of at least one of a powder X-ray diffraction pattern having peaks at about 4.1, 8.2, 12.3, and 13.4 degrees two-theta±0.2 degrees two-theta and a powder X-ray diffraction pattern as depicted in FIG. 1, in the preparation of ibandronate sodium.

In yet another embodiment, the invention encompasses a crystalline ibandronic acid characterized by data selected from the group consisting of at least one of a powder X-ray diffraction pattern having peaks at about 5.2, 11.7, and 18.7±0.2 degrees two-theta and at least two more peaks selected from the group consisting of: 5.8, 10.1, 12.0, 17.1, and 20.0±0.2 degrees two-theta, and a powder X-ray diffraction pattern as depicted in FIG. 2.

In one embodiment, the invention encompasses a process for preparing the crystalline ibandronic acid characterized by data selected from the group consisting of at least one of a powder X-ray diffraction pattern having peaks at about 5.2, 11.7, and 18.7±0.2 degrees two-theta and at least two more peaks selected from the group consisting of: 5.8, 10.1, 12.0, 17.1, and 20.0±0.2 degrees two-theta, and a powder X-ray diffraction pattern as depicted in FIG. 2, comprising: dissolving ibandronic acid in water and adding ethanol to obtain the crystalline form, and recovering the crystalline ibandronic acid by a suitable means. In another embodiment, ethylenediaminetetraacetic acid (“EDTA”) may be combined with ibandronic acid and water. Preferably, the mixture of ibandronic acid, water, and EDTA is stirred and filtered before adding ethanol.

In another embodiment, the invention encompasses a process for preparing ibandronate sodium comprising preparing crystalline ibandronic acid characterized by data selected from the group consisting of at least one of a powder X-ray diffraction pattern having peaks at about 5.2, 11.7, and 18.7±0.2 degrees two-theta and at least two more peaks selected from the group consisting of: 5.8, 10.1, 12.0, 17.1, and 20.0±0.2 degrees two-theta, and a powder X-ray diffraction pattern as depicted in FIG. 2 by the above-described process, and converting the crystalline ibandronic acid into ibandronate sodium.

In yet another embodiment, the invention encompasses the use of the crystalline ibandronic acid characterized by data selected from the group consisting of at least one of a powder X-ray diffraction pattern having peaks at about 5.2, 11.7, and 18.7±0.2 degrees two-theta and at least two more peaks selected from the group consisting of: 5.8, 10.1, 12.0, 17.1, and 20.0±0.2 degrees two-theta, and a powder X-ray diffraction pattern as depicted in FIG. 2, in the preparation of ibandronate sodium.

### BRIEF DESCRIPTION OF THE DRAWINGS

FIG. 1 illustrates a powder X-ray diffraction pattern of crystalline ibandronic acid characterized a powder X-ray diffraction pattern having peaks at about 4.1, 12.3, and 13.4 degrees two-theta±0.2 degrees two-theta and at least two more peaks selected from the group consisting of: 8.2, 11.3, 16.2, 16.9, and 20.8±0.2 degrees two-theta

FIG. 2 illustrates a powder X-ray diffraction pattern of crystalline ibandronic acid characterized by a powder X-ray diffraction pattern having peaks at about 5.2, 11.7, and 18.7±0.2 degrees two-theta and at least two more peaks selected from the group consisting of: 5.8, 10.1, 12.0, 17.1, and 20.0±0.2 degrees two-theta.

### DETAILED DESCRIPTION OF THE INVENTION

As used herein, the terms “reduced pressure” or “vacuum” refer to a pressure of less than about 100 mmHg.

The invention provides crystalline forms of ibandronic acid and processes for their preparation.

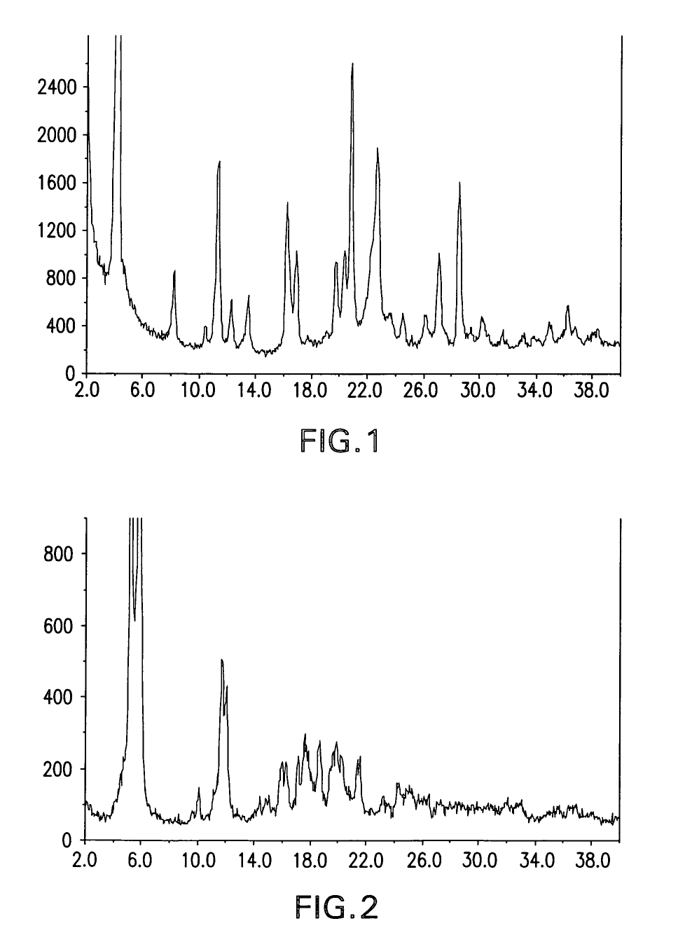

The invention encompasses crystalline ibandronic acid characterized by data selected from the group consisting of at least one of a powder X-ray diffraction (“PXRD”) pattern having peaks at about 4.1, 12.3 and 13.4±0.2 degrees two-theta and at least two more peaks selected from the group consisting of: 8.2, 11.3, 16.2 16.9, and 20.8±0.2 degrees two-theta and a PXRD pattern as depicted in FIG. 1.

In a preferred embodiment, the crystalline ibandronic acid is characterized by a PXRD pattern having peaks at about 4.1, 8.2, 12.3 and 13.4 degrees two-theta±0.2 degrees two-theta. This crystalline ibandronic acid may be further characterized by a PXRD pattern having peaks at about 11.3, 16.2, 16.9 and 20.8 degrees two-theta±0.2 degrees two-theta.

Optionally, the crystalline form is characterized by a PXRD pattern having peaks at about 4.1, 8.2, 11.3, 12.3 and 13.4 degrees two-theta±0.2 degrees two-theta.

Typically, the crystalline ibandronic acid is a 1-butanol solvate of ibandronic acid. The butanol content is about 15 to about 20 percent by weight, more preferably about 16 to about 18 percent by weight (% wt).

Preferably, the crystalline ibandronic acid has less than about 5% of crystalline ibandronic acid Form S1, more preferably less than about 3%. Typically, the content of the crystalline ibandronic acid Form S1 is measured as percent by weight. Preferably, the percent by weight of the crystalline ibandronic acid Form S1 is measured by PXRD using the peaks at 11.9, 13.9, 18.6 and 22.2±0.2 degrees two-theta.

In another embodiment, the invention encompasses a process for preparing the above-described crystalline ibandronic acid comprising slurrying crystalline ibandronic acid Form S1 in 1-butanol.

The starting crystalline ibandronic acid Form S1 that is slurried in the 1-butanol can be obtained, for example, by the method disclosed in International Publication No. WO 2006/002348, hereby incorporated by reference.

Typically, the crystalline ibandronic acid, preferably Form S1 is combined with 1-butanol to obtain a slurry and the slurry is maintained for a period of time sufficient to obtain the above-described crystalline ibandronic acid. In one embodiment, the crystalline ibandronic acid Form S1 is slurried in 1-butanol for about 10 to about 36 hours, more preferably for about 15 to about 30 hours, most preferably, for about 24 hours to produce the above-described crystalline ibandronic acid. Preferably the slurry is at a temperature of about 20° C. to about 40° C., more preferably at about 20° C. to about 25° C. The ratio of 1-butanol to ibandronic acid is preferably about 20 ml/g to about 40 ml/g, more preferably about 30 ml/g.

The crystalline ibandronic acid thus obtained may be recovered from the slurry by any method known to one of ordinary skill in the art. Such methods include, but are not limited to, collecting the crystalline ibandronic acid from the slurry by filtration and drying the collected crystalline ibandronic acid. Preferably, the crystalline ibandronic acid is dried under vacuum. Vacuum filtration can be used to facilitate the recovery. Drying can be carried out under reduced pressure and/or elevated temperature of about 40° C. to about 60° C., preferably about 50° C. Drying can be carried out for a suitable time, such as about 6 hours to about 48 hours, more preferably about 20 hours to about 30 hours, depending on the conditions used.

In another embodiment, the invention encompasses a process for preparing ibandronate sodium from the above-described crystalline ibandronic acid. Preferably, the process comprises: (a) preparing crystalline ibandronic acid characterized by data selected from the group consisting of at least one of a PXRD pattern having peaks at about 4.1, 12.3, and 13.4±0.2 degrees two-theta and at least two more peaks selected from the group consisting of: 8.2, 11.3, 16.2, 16.9 and 20.8±0.2 degrees two-theta and a PXRD pattern as depicted in FIG. 1 by the above-described process; and (b) converting the crystalline ibandronic acid into ibandronate sodium.

The crystalline ibandronic acid described above is a useful intermediate in the preparation of ibandronate sodium. The crystalline ibandronic acid of this invention may be converted into ibandronate sodium by any method known to one of ordinary skill in the art. Such methods include, for example, the method described in PCT publication no. WO2006/024024, hereby incorporated by reference.

Thus, in another embodiment, the invention encompasses the use of the crystalline ibandronic acid characterized by data selected from the group consisting of at least one of a powder X-ray diffraction pattern having peaks at about about 4.1, 12.3, and 13.4±0.2 degrees two-theta and at least two more peaks selected from the group consisting of: 8.2, 11.3, 16.2, 16.9 and 20.8±0.2 degrees two-theta and a powder X-ray diffraction pattern as depicted in FIG. 1, in the preparation of ibandronate sodium.

The invention also encompasses crystalline ibandronic acid characterized by data selected from the group consisting of at least one of a powder X-ray diffraction pattern having peaks at about 5.2, 11.7, and 18.7±0.2 degrees two-theta and at least two more peaks selected from the group consisting of: 5.8, 10.1, 12.0, 17.1, and 20.0±0.2 degrees two-theta, and a PXRD pattern as depicted in FIG. 2.

The crystalline ibandronic acid may be characterized by a PXRD pattern having peaks at about 5.2, 10.1, 11.7, 12.0, and 18.7 degrees two-theta±0.2 degrees two-theta.

In another embodiment, the present invention encompasses a process for preparing the crystalline form of ibandronic acid characterized by data selected from the group consisting of at least one of a powder X-ray diffraction pattern having peaks at about 5.2, 11.7, and 18.7±0.2 degrees two-theta and at least two more peaks selected from the group consisting of: 5.8, 10.1, 12.0, 17.1, and 20.0±0.2 degrees two-theta comprising: dissolving ibandronic acid in water and adding ethanol to obtain the crystalline form.

Preferably, the amount of water used to dissolve ibandronic acid in the foregoing paragraph is about a 0.5:1 to about a 10:1 ratio of water to ibandronic acid v/w. More preferably, the amount of water is about a 1:1 to about a 3:1 ratio of water to ibandronic acid v/w. Preferably, the amount of ethanol added to obtain the foregoing crystalline form of ibandronic acid is about a 5:1 to about a 30:1 ratio of ethanol to water v/v. More preferably, the amount of ethanol is about a 10:1 to about a 20:1 ratio of ethanol to water v/v. Preferably, the amount of water used to dissolve ibandronic acid in the foregoing paragraph is about a 0.5:1 to about a 10:1 ratio of water to ibandronic acid v/w. More preferably, the amount of water is about a 1:1 to about a 3:1 ratio of water to ibandronic acid v/w. Preferably, the amount of ethanol added to obtain the foregoing crystalline form of ibandronic acid is about a 5:1 to about a 30:1 ratio of ethanol to water v/v. More preferably, the amount of ethanol is about a 10:1 to about a 20:1 ratio of ethanol to water v/v. Ethylenediaminetetraacetic acid (“EDTA”) can also be combined with water and ibandronic acid. The resulting mixture can be stirred, such as for a period of about 2 about 6 hours. More preferably, the stirring is performed for a period of about 2 hours. Preferably, prior to the addition of ethanol, the solution of ibandronic acid is filtered to remove insoluble components, particularly EDTA.

Preferably, the amount of EDTA employed in the foregoing paragraph is about a 1:5 to about a 1:50 ratio of EDTA to ibandronic acid w/w. More preferably, amount of EDTA is about 1 g EDTA added to about about 1:10 to about a 1:20 ratio of EDTA to ibandronic acid w/w.

The crystalline ibandronic acid obtained following the addition of ethanol may be recovered by any method known to one of ordinary skill in the art. The recovery may be done by filtering, washing and drying. Preferably, the washing is with ethanol. Preferably, the drying is under vacuum at a temperature of about 50° C. to about 80° C., more preferably, at a temperature of about 80° C. The drying may be performed for about 12 hours to about 72 hours, more preferably, for about 12 hours.

The crystalline ibandronic acid described above is a useful intermediate in the preparation of ibandronate sodium. The crystalline ibandronic acid of this invention may be converted into ibandronate sodium by any method known to one of ordinary skill in the art. Such methods include, for example, the method described in PCT publication no. WO2006/024024, hereby incorporated by reference.

In yet another embodiment, the invention encompasses the use of the crystalline ibandronic acid characterized by data selected from the group consisting of a powder X-ray diffraction pattern having peaks at about 5.2, 11.7, and 18.7±0.2 degrees two-theta and at least two more peaks selected from the group consisting of: 5.8, 10.1, 12.0, 17.1, and 20.0±0.2 degrees two-theta and a PXRD pattern as depicted in FIG. 2 in the preparation of ibandronate sodium.

The crystalline ibandronic acid forms of the present invention may subsequently be converted into a pharmaceutically acceptable salt of ibandronic acid by any method known to one of ordinary skill in the art. Preferably, the method comprises: preparing crystalline ibandronic acid forms of the present invention according to the above-described processes; and converting the crystalline ibandronic acid forms into a pharmaceutically acceptable salt of ibandronic acid. Preferably, the pharmaceutically acceptable salt is a sodium salt.

The crystalline ibandronic acid Forms of the present invention, or pharmaceutically acceptable salts of ibandronic acid prepared the crystalline forms, may be formulated into pharmaceutical formulations with at least one pharmaceutically acceptable excipient.

Suitable pharmaceutically acceptable excipients include those known to one of ordinary skill in the art. Excipients are added to the formulation for a variety of purposes.

Diluents increase the bulk of a solid pharmaceutical composition, and can make a pharmaceutical dosage form containing the composition easier for the patient and caregiver to handle. Diluents for solid compositions include, for example, microcrystalline cellulose (e.g. AVICEL®), microfine cellulose, lactose, starch, pregelatinized starch, calcium carbonate, calcium sulfate, sugar, dextrates, dextrin, dextrose, dibasic calcium phosphate dihydrate, tribasic calcium phosphate, kaolin, magnesium carbonate, magnesium oxide, maltodextrin, mannitol, polymethacrylates (e.g. EUDRAGIT®), potassium chloride, powdered cellulose, sodium chloride, sorbitol, and talc.

Solid pharmaceutical compositions that are compacted into a dosage form, such as a tablet, can include excipients whose functions include helping to bind the active ingredient and other excipients together after compression. Binders for solid pharmaceutical compositions include acacia, alginic acid, carbomer (e.g. CARBOPOL®), carboxymethylcellulose sodium, dextrin, ethyl cellulose, gelatin, guar gum, hydrogenated vegetable oil, hydroxyethyl cellulose, hydroxypropyl cellulose (e.g. KLUCEL®), hydroxypropyl methyl cellulose (e.g. METHOCEL®), liquid glucose, magnesium aluminum silicate, maltodextrin, methylcellulose, polymethacrylates, povidone (e.g. KOLLIDON®, PLASDONE®), pregelatinized starch, sodium alginate, and starch.

The dissolution rate of a compacted solid pharmaceutical composition in the patient's stomach can be increased by the addition of a disintegrant to the composition. Disintegrants include alginic acid, carboxymethylcellulose calcium, carboxymethylcellulose sodium (e.g. AC-DI-SOL®, PRIMELLOSE®), colloidal silicon dioxide, croscarmellose sodium, crospovidone (e.g. KOLLIDON®, POLYPLASDONE®), guar gum, magnesium aluminum silicate, methyl cellulose, microcrystalline cellulose, polacrilin potassium, powdered cellulose, pregelatinized starch, sodium alginate, sodium starch glycolate (e.g. EXPLOTAB®), and starch.

Glidants can be added to improve the flowability of a non-compacted solid composition and to improve the accuracy of dosing. Excipients that can function as glidants include colloidal silicon dioxide, magnesium trisilicate, powdered cellulose, starch, talc, and tribasic calcium phosphate.

When a dosage form such as a tablet is made by the compaction of a powdered composition, the composition is subjected to pressure from a punch and dye. Some excipients and active ingredients have a tendency to adhere to the surfaces of the punch and dye, which can cause the product to have pitting and other surface irregularities. A lubricant can be added to the composition to reduce adhesion and ease the release of the product from the dye. Lubricants include magnesium stearate, calcium stearate, glyceryl monostearate, glyceryl palmitostearate, hydrogenated castor oil, hydrogenated vegetable oil, mineral oil, polyethylene glycol, sodium benzoate, sodium lauryl sulfate, sodium stearyl fumarate, stearic acid, talc, and zinc stearate.

Flavoring agents and flavor enhancers make the dosage form more palatable to the patient. Common flavoring agents and flavor enhancers for pharmaceutical products that can be included in the composition of the invention include maltol, vanillin, ethyl vanillin, menthol, citric acid, fumaric acid, ethyl maltol, and tartaric acid.

Solid and liquid compositions can also be dyed using any pharmaceutically acceptable colorant to improve their appearance and/or facilitate patient identification of the product and unit dosage level.

In liquid pharmaceutical compositions of the invention, the crystalline ibandronic acid or pharmaceutically acceptable salt thereof and any other solid excipients are suspended in a liquid carrier such as water, vegetable oil, alcohol, polyethylene glycol, propylene glycol, or glycerin, wherein the crystalline form of the ibandronic acid is maintained.

Liquid pharmaceutical compositions can contain emulsifying agents to disperse uniformly throughout the composition an active ingredient or other excipient that is not soluble in the liquid carrier. Emulsifying agents that can be useful in liquid compositions of the invention include, for example, gelatin, egg yolk, casein, cholesterol, acacia, tragacanth, chondrus, pectin, methyl cellulose, carbomer, cetostearyl alcohol, and cetyl alcohol.

Liquid pharmaceutical compositions of the invention can also contain a viscosity enhancing agent to improve the mouth-feel of the product and/or coat the lining of the gastrointestinal tract. Such agents include acacia, alginic acid bentonite, carbomer, carboxymethylcellulose calcium or sodium, cetostearyl alcohol, methyl cellulose, ethylcellulose, gelatin guar gum, hydroxyethyl cellulose, hydroxypropyl cellulose, hydroxypropyl methyl cellulose, maltodextrin, polyvinyl alcohol, povidone, propylene carbonate, propylene glycol alginate, sodium alginate, sodium starch glycolate, starch tragacanth, and xanthan gum.

Sweetening agents such as sorbitol, saccharin, sodium saccharin, sucrose, aspartame, fructose, mannitol, and invert sugar can be added to improve the taste.

Preservatives and chelating agents such as alcohol, sodium benzoate, butylated hydroxyl toluene, butylated hydroxyanisole, and ethylenediamine tetraacetic acid can be added at levels safe for ingestion to improve storage stability.

According to the invention, a liquid composition can also contain a buffer such as gluconic acid, lactic acid, citric acid, or acetic acid, sodium gluconate, sodium lactate, sodium citrate, or sodium acetate. Selection of excipients and the amounts used can be readily determined by the formulation scientist based upon experience and consideration of standard procedures and reference works in the field.

The solid compositions of the invention include powders, granulates, aggregates, and compacted compositions. The dosages include dosages suitable for oral, buccal, rectal, parenteral (including subcutaneous, intramuscular, and intravenous), inhalant, and ophthalmic administration. Although the most suitable administration in any given case will depend on the nature and severity of the condition being treated, the most preferred route of the invention is oral. The dosages can be conveniently presented in unit dosage form and prepared by any of the methods well-known in the pharmaceutical arts.

Dosage forms include solid dosage forms like tablets, powders, capsules, suppositories, sachets, troches, and lozenges, as well as liquid syrups, suspensions, and elixirs.

The dosage form of the invention can be a capsule containing the composition, preferably a powdered or granulated solid composition of the invention, within either a hard or soft shell. The shell can be made from gelatin and optionally contain a plasticizer such as glycerin and sorbitol, and an opacifying agent or colorant.

The active ingredient and excipients can be formulated into compositions and dosage forms according to methods known in the art.

A composition for tableting or capsule filling can be prepared by wet granulation. In wet granulation, some or all of the active ingredients and excipients in powder form are blended and then further mixed in the presence of a liquid, typically water, that causes the powders to clump into granules. The granulate is screened and/or milled, dried, and then screened and/or milled to the desired particle size. The granulate can then be tableted, or other excipients can be added prior to tableting, such as a glidant and/or a lubricant.

A tableting composition can be prepared conventionally by dry blending. For example, the blended composition of the actives and excipients can be compacted into a slug or a sheet and then comminuted into compacted granules. The compacted granules can subsequently be compressed into a tablet.

As an alternative to dry granulation, a blended composition can be compressed directly into a compacted dosage form using direct compression techniques. Direct compression produces a more uniform tablet without granules. Excipients that are particularly well suited for direct compression tableting include microcrystalline cellulose, spray dried lactose, dicalcium phosphate dihydrate, and colloidal silica. The proper use of these and other excipients in direct compression tableting is known to those in the art with experience and skill in particular formulation challenges of direct compression tableting.

A capsule filling of the invention can comprise any of the aforementioned blends and granulates that were described with reference to tableting, but they are not subjected to a final tableting step.

The invention also provides methods of treating bone disorders comprising administering a pharmaceutical formulation of ibandronic acid or a pharmaceutically acceptable salt thereof to a patient in need thereof. Bone disorders include, but are not limited to hypercalcaemia of malignancy, osteolysis, Paget's disease, osteoporosis and metastatic bone disease. Ibandronic acid or a pharmaceutically acceptable salt thereof is preferably formulated for administration by injection, preferably to a mammal, more preferably to a human. Ibandronic acid can be formulated, for example, as a viscous liquid suspension for injection. The formulation can contain one or more solvents. A suitable solvent can be selected by considering the solvent's physical and chemical stability at various pH levels, viscosity (which would allow for syringeability), fluidity, boiling point, miscibility, and purity. Suitable solvents include alcohol USP, benzyl alcohol NF, benzyl benzoate USP, and Castor oil USP. Additional substances can be added to the formulation such as buffers, solubilizers, and antioxidants, among others. Ansel et al., Pharmaceutical Dosage Forms and Drug Delivery Systems, 7th ed.

BONIVA® and/or BONDRONAT® can be used as guidance for formulation. BONIVA® is available as an intravenous injection administered every 2-3 months and as an oral formulation. BONDRONAT® is available in ampoule with 1 ml concentrate for solution for infusion contains 1.125 mg of ibandronic monosodium salt monohydrate, corresponding to 1 mg of ibandronic acid.

Having thus described the invention with reference to particular preferred embodiments, other embodiments will become apparent to one skilled in the art from consideration of the specification. The invention is further defined by reference to the following examples describing in detail the synthesis of ibandronic acid Forms of the present invention. The Examples are set forth to aid in understanding the invention but are not intended to, and should not be construed to, limit its scope in any way. The examples do not include detailed descriptions of conventional methods. Such methods are well known to those of ordinary skill in the art and are described in numerous publications.

### EXAMPLES

### Instrumentation

### Powder X-Ray Diffraction

Powder X-ray diffraction was performed on Scintag X-ray powder diffractometer model X'TRA with a solid state detector. Copper radiation of 1.5418 Å was used. The sample holder was a round standard aluminum sample holder with rough zero background. The scanning parameters were range: 2-40 degrees two-theta; scan mode: continuous scan; step size: 0.05 deg.; and at a rate of 3 deg/min.

### HPLC

Column & Packing: Phenomenex Luna Phenyl Hexyl 5 μm, 250*4.6 mm p/No OOG-4257-EO

Temp.: 35° C.

Buffer: 0.1% (v/v) TFA, 0.1%(v/v) TEA, 0.025% (w/v) EDTA/1 liter water solution. Buffer adjusted to pH 2.3±0.05,

Solvent: Ethanol: Acetonitrile (1:1) (v/v),

Eluent: 94:6 Buffer: Solvent

Flow Rate: 1.2 mL/min,

Diluent: 1%(v/v) TFA, 0.025%(w/v) EDTA/1 liter water solution.

Sample: volume 30 μL,

Detector: Refractive Index

### Example 1

### Preparation Of Crystalline Ibandronic Acid Characterized By Data Selected From The Group Consisting Of At Least One Of A Powder X-Ray Diffraction Pattern Having Peaks At About 4.1. 12.3. And 13.4 Degrees Two-Theta±0.2 Degrees Two-Theta And At Least Two More Peaks Selected From The Group Consisting Of: 8.2, 11.3, 16.2, 16.9, And 20.8±0.2 Degrees Two-Theta And A PXRD Pattern As Depicted In FIG. 1

A slurry of crystalline ibandronic acid Form S1 (5.0 g) and 1-butanol (150 ml) was stirred at room temperature for 21 hours. The precipitate was isolated by vacuum filtration under nitrogen and dried in a vacuum oven at 50° C. for 24 hours to obtain 5.72 g of ibandronic acid.

### Example b 2

### Preparation of Crystalline Ibandronic Acid Characterized by Data Selected from the Group Consisting A PXRD Pattern Having Peaks at about 5.2, 11.7. and 18.7±0.2 Degrees Two-Theta and at Least Two More Peaks Selected from the Group Consisting of: 5.8, 10.1. 12.0. 17.1, and 20.0±0.2 Degrees Two-Theta And A PXRD Pattern As Depicted In FIG. 2

28.5 g of ibandronic acid, 57.5 ml water and 1.87 g of EDTA were introduced into 1 liter reactor. The solution was stirred for 2 hours and then mechanically filtered. 850 ml of EtOH absolute was added. The mixture was filtered and washed with 50 ml EtOH abs after 72 hours. This material was dried in vacuum oven at 80° C. overnight.

### Reference Example 3

### Preparation of Crystalline Ibandronic Acid Form S1 according to WO 2006/002348, Example 5

Amorphous ibandronic acid (3.0 g) was dissolved in water (4 ml) at room temperature. Acetone (70 mL) was added to the stirred solution. A white slurry was obtained while stirring at room temperature for 68 hours. The precipitate was then isolated by vacuum filtration, washed with acetone (2×25 ml) and dried in a vacuum oven at 50° C. for 24 hours to obtain 2.5 g of ibandronic acid crystalline form S1.

### Reference Example 4

### Preparation of Crystalline Ibandronate Sodium Form F According to WO 2006/024024, Example 10

A solution of sodium hydroxide (0.63 g) in water:IPA (60:40 v/v, 19 ml) was added dropwise to a solution of amorphous ibandronic acid (5 g) in water:IPA (60:40 v/v, 106 ml) at reflux temperature. The reaction mixture was heated at reflux temperature for an additional 30 minutes to obtain a pH of 4.14. Then the reaction mixture was cooled to room temperature and stirred for 16 hours. Further cooling was performed using an ice-bath. The precipitate was filtered, washed with IPA (2×25 ml), and dried in a vacuum oven at 50° C. for 23 hours to give 5.2 g of ibandronate sodium crystal form F.

1. A crystalline form of ibandronic acid characterized by data selected from the group consisting of at least one of a) a powder x-ray diffraction peaks at about 4.1, 12.3 and 13.4±0.2 degrees two-theta and at least two more peaks selected from the group consisting of: 8.2, 11.3, 16.2 16.9, and 20.8±0.2 degrees two-theta, and b) a powder x-ray diffraction pattern as depicted in FIG. 1.

2. The crystalline ibandronic acid of claim 1, wherein the crystalline form is characterized by a powder x-ray diffraction pattern having peaks at about 4.1, 12.3 and 13.4±0.2 degrees two-theta and at least two more peaks selected from the group consisting of: 8.2, 11.3, 16.2 16.9, and 20.8±0.2 degrees two-theta.

3. The crystalline form of ibandronic acid of claim 1, wherein the crystalline form is characterized by a powder x-ray diffraction pattern as depicted in FIG. 1.

4. The crystalline form of ibandronic acid of claim 2, wherein the crystalline form is characterized a powder x-ray diffraction pattern having peaks at about 4.1, 8.2, 12.3 and 13.4 degrees two-theta±0.2 degrees two-theta.

5. The crystalline form of ibandronic acid of claim 4, further characterized by a PXRD pattern having peaks at about 11.3, 16.2, 16.9 and 20.8 degrees two-theta±0.2 degrees two-theta.

6. The crystalline form of ibandronic acid of claim 2, wherein the crystalline form is characterized a powder x-ray diffraction pattern having peaks at about 4.1, 8.2, 11.3, 12.3 and 13.4 degrees two-theta±0.2 degrees two-theta.

7. The crystalline ibandronic acid of claim 1, wherein the crystalline ibandronic acid is a 1-butanol solvate of ibandronic acid.

8. The crystalline form of ibandronic acid of claim 7, wherein the butanol content is about 15 to about 20 percent by weight.

9. The crystalline form of ibandronic acid of claim 8, wherein the butanol content is about 16 to about 18 as percent by weight.

10. The crystalline ibandronic acid of claim 1, wherein the crystalline ibandronic acid has less than about 5% of crystalline ibandronic acid having powder x-ray diffraction peaks at 11.9, 13.9, 18.6 and 22.2±0.2 degrees two-theta.

11. A process for preparing the crystalline ibandronic acid of claim 1, comprising slurrying ibandronic acid in 1-butanol to obtain the crystalline form.

12. The process of claim 11, wherein the crystalline form that is slurried has a powder x-ray diffraction peaks at 11.9, 13.9, 18.6 and 22.2±0.2 degrees two-theta.

13. The process of claim 11, wherein the slurry is maintained for about 10 to about 36 hours, preferably for about 15 to about 25 hours.

14. The process of claim 11, wherein the slurry is at a temperature of about 20° C. to about 40° C., preferably at about 20° C. to about 25° C.

15. The process of claim 11, wherein the ratio of 1-butanol to ibandronic acid is about 20 ml/g to about 40 ml/g.

16. The process of claim 11, further comprising recovering the crystalline ibandronic acid.

17. A process for preparing ibandronate sodium comprising converting the crystalline ibandronic acid of claim 11 to ibandronate sodium.

18. A crystalline form of ibandronic acid characterized by data selected from the group consisting of at least one of a) a powder x-ray diffraction peaks at about 5.2, 11.7, and 18.7±0.2 degrees two-theta and at least two more peaks selected from the group consisting of: 5.8, 10.1, 12.0, 17.1, and 20.0±0.2 degrees two-theta, and b) a powder x-ray diffraction pattern as depicted in FIG. 2.

19. The crystalline form of ibandronic acid of claim 18, characterized by a powder x-ray diffraction pattern having peaks at about 5.2, 11.7, and 18.7±0.2 degrees two-theta and at least two more peaks selected from the group consisting of: 5.8, 10.1, 12.0, 17.1, and 20.0±0.2 degrees two-theta.

20. The crystalline form of ibandronic acid of claim 18, wherein the crystalline form is characterized by a powder x-ray diffraction pattern as depicted in FIG. 2.

21. The crystalline form of ibandronic acid of claim 18, characterized by a powder x-ray diffraction pattern having peaks at about 5.2, 10.1, 11.7, 12.0, and 18.7 degrees two-theta±0.2 degrees two-theta.

22. A process for preparing the crystalline form of ibandronic acid of claim 18 comprising: dissolving ibandronic acid in water and adding ethanol to obtain the crystalline form.

23. The process of claim 22, wherein the amount of water used to dissolve ibandronic acid is about a 0.5:1 to about a 10:1 ratio of water to ibandronic acid v/w.

24. The process of claim 22, wherein the amount of water used to dissolve ibandronic acid is about a 1:1 to about a 3:1 ratio of water to ibandronic acid v/w.

25. The process of claim 22, wherein the amount of ethanol added to obtain the crystalline form of ibandronic acid is about a 10:1 to about a 20:1 ratio of ethanol to water v/v.

26. The process of claim 22, wherein the process comprises combining ethylenediaminetetraacetic, ibandronic acid and water to obtain a mixture, optionally stirring the mixture, and filtering the mixture prior to adding ethanol.

27. The process of claim 27, wherein the amount of ethylenediaminetetraacetic acid is about a 1:5 to about a 1:50 ratio of ethylenediaminetetraacetic acid to ibandronic acid w/w.

28. The process of claim 27, wherein the amount of ethylenediaminetetraacetic acid is about a 1:10 to about a 1:20 ratio of ethylenediaminetetraacetic acid to ibandronic acid w/w.

29. The process of claim 22, further comprising recovering the crystalline ibandronic acid.

30. A process for preparing ibandronate sodium comprising converting the crystalline ibandronic acid of claim 22 to ibandronate sodium.
